(19) United States
(12) Patent Application Publication
(10) Pub. No.: US 2004/0193586 A1
(43) Pub. Date: Sep. 30, 2004

(54) Database search system and method

(75) Inventors: Naoki Sashida, Kawasaki (JP); Akihiko Obata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/766,926

(22) Filed: Jan. 30, 2004

(30) Foreign Application Priority Data
Mar. 24, 2003 (JP) 2003-081135

(51) Int. Cl. G06F 17/30

(52) U.S. Cl. 707/3

(57) ABSTRACT

A database search system for searching a database for data measures an input number of search conditions input during a period from a start to an end of search processing or a necessary time taken from the start to the end of the search processing, receives an input of a message describing know-how information corresponding to contents of the search processing from a user, in a case where the measured input number exceeds a predetermined threshold value, and stores the input message under a condition that the input message is associated with a predetermined search condition during an execution period of the search processing. During execution of the search processing, the search conditions input by the user are compared with stored search conditions every time the search conditions are received, and in a case where a plurality of or more search conditions are matched with each other, the associated message is output to the user.

### BACKGROUND OF THE INVENTION

1. Field of the Invention

The present invention relates to a database search system and method for searching a database for desired data. In particular, the present invention relates to a database search system and method allowing system users to effectively share know-how for performing search processing.

2. Description of the Related Art

Recently, a database search technique has been used in various applications such as a web search system, a CRM system, an in-company information management system, or the like. For example, even in call center service as a front line connecting a company to a client, the importance of which starts being recognized again rapidly in recent years, a database search system for managing client information such as an address, a name, a profile, etc. is positioned as a core knowledge system.

Such a database search system functions as a very strong tool for immediately searching for corresponding client information and the like from a large amount of data during interaction with a user. However, in some cases, due to the uncertainty or ambiguity of a search conditional expression, a large amount of similar client information registered in a database, and the like, a considerable amount of time may be required for specifying truly desired data.

For example, in the case where Chinese characters of client addresses registered in a database are likely to be mixed-up, in the case where names of client companies are confusing due to the similarity, in the case where companies related to each other are registered as different names, or the like, the above-mentioned tendency is conspicuous.

In this case, it is necessary to repeat a series of operations from “input of a search conditional expression” to “search execution”, and consequently, a large amount of time and labor will be consumed by the time when the search is completed.

Basically, each user generally acquires know-how for generating a search expression in a call center system and the like based on his/her own trial and error. Such know-how may be transmitted in an informal manner through word of mouth or the like; however, there are not necessarily a number of mechanisms actively shared by users.

Conventionally, individual users voluntarily record or input such know-how when they recognize it, and accumulate it at a time in a database that can be shared by users. However, merely recording and storing information on know-how does not make it easy to sufficiently use the know-how during actual execution of search. Furthermore, each user determines whether or not information on know-how should be recorded in a database. Therefore, some know-how may not be recorded even if it is very important.

In order to solve the above-mentioned problem, for example, JP 2002-215638 A discloses a search system that does not merely record information on know-how in a database. More specifically, in addition to information on know-how, the search system records an evaluation value of importance regarding each information on know-how under the condition that it is associated with the information. Thus, important information or useful information can be searched for earlier during search.

### SUMMARY OF THE INVENTION

It is an object of the present invention to provide a database search system and method allowing information on know-how useful for search processing found by each user of a search system during execution of search processing to be used by users.

In order to achieve the above-mentioned object, a first database search system according to the present invention searches a database for data, and includes: a unit for measuring an input number of search conditions input during a period from a start to an end of search processing; a unit for receiving an input of a message describing know-how information corresponding to contents of the search processing from a user, in a case where the input number measured at the end of the search processing exceeds a predetermined threshold value; and a unit for storing the input message in a know-how database under a condition that the input message is associated with all the search conditions input during an execution period of the search processing.

Furthermore, in order to achieve the above-mentioned object, a second database search system according to the present invention searches a database for data, and includes: a unit for measuring a necessary time taken from a start to an end of search processing; a unit for receiving an input of a message describing know-how information corresponding to contents of the search processing from a user, in a case where the necessary time measured at the end of the search processing exceeds a predetermined threshold value; and a unit for storing the input message in a know-how database under a condition that the input message is associated with all the search conditions input during an execution period of the search processing.

According to the above-mentioned configuration, a user is prompted to register precautions, know-how for interpreting data, and the like to be output in accordance with an input situation of search conditions in user's search processing under a condition that precautions, know-how for interpreting data, and the like are associated with the search conditions, without being aware of registration. Therefore, the user can register know-how without fail.

These and other advantages of the present invention will become apparent to those skilled in the art upon reading and understanding the following detailed description with reference to the accompanying figures.

### BRIEF DESCRIPTION OF THE DRAWINGS

FIG. 1 is a view showing a configuration of an accumulation system of information on know-how in a database search system according to an embodiment of the present invention.

FIG. 2 is a view showing another configuration of an accumulation system of information on know-how in the database search system according to the embodiment of the present invention.

FIG. 3 is a view showing a configuration of a reference system of information on know-how in the database search system according to the embodiment of the present invention.

FIG. 4 is a flow diagram showing accumulation processing of information on know-how in the database search system according to the embodiment of the present invention.

FIG. 5 is a flow diagram showing reference processing of information on know-how in the database search system according to the embodiment of the present invention.

FIG. 6 is a diagram showing a configuration of an accumulation system of information on know-how in a client database search system according to an example of the present invention.

FIG. 7 is a diagram showing a configuration of a reference system of information on know-how in the client database search system according to the example of the present invention.

FIG. 8 illustrates a screen configuration of the client database search system according to the example of the present invention.

FIG. 9 illustrates a data configuration of an apparatus database in the client database search system according to the example of the present invention.

FIG. 10 illustrates a know-how database data configuration in the client database search system according to the example of the present invention.

FIG. 11 illustrates a computer environment.

### DESCRIPTION OF THE PREFERRED EMBODIMENTS

However, even in the search system disclosed by JP 2002-215638 A, a user determines whether or not information on know-how should be recorded. Therefore, there still remains a possibility that important information on know-how is not recorded.

Furthermore, during search of a database, it is necessary to directly refer to a database storing information on know-how, and it is also necessary to input a search condition of information on know-how separately from search processing performed in an application. Thus, an operation burden on a user is excessive.

In the first and second database search systems according to the present invention, it is preferable that during execution of the search processing, the search conditions input by the user are compared with search conditions stored in the know-how database every time the search conditions are received, and in a case where a predetermined number of or more search conditions are matched with each other, the message associated with the search conditions stored in the know-how database is output to the user. According to this configuration, a user can see precautions during search, know-how for interpreting data, and the like in accordance with an input situation of search conditions in user's search processing without user's intentional search.

Furthermore, in the first and second database search systems according to the present invention, it is preferable that when the user inputs the message on know-how, another or a plurality of users to be provided with the message is specified, and the message is output only to another or a plurality of users. According to this configuration, know-how can be prevented from being presented to users who do not require the know-how.

Furthermore, in the first and second database search systems according to the present invention, it is preferable that the message is voice data storing uttered contents of the user.

Furthermore, in the first and second database search systems according to the present invention, it is preferable that when the user inputs the message on know-how, the search condition which is associated with know-how is selectable by the user from a plurality of the search conditions.

Furthermore, a first database search method according to the present invention for searching a database for data includes; measuring an input number of search conditions input during a period from a start to an end of search processing; receiving an input of a message describing know-how information corresponding to contents of the search processing from a user, in a case where the input number measured at the end of the search processing exceeds a predetermined threshold value; and storing the input message in a know-how database under a condition that the input message is associated with all the search conditions input during an execution period of the search processing.

Furthermore, a second database search method according to the present invention for searching a database for data includes; measuring a necessary time taken from a start to an end of search processing; receiving an input of a message describing know-how information corresponding to contents of the search processing from a user, in a case where the necessary time measured at the end of the search processing exceeds a predetermined threshold value; and storing the input message in a know-how database under a condition that the input message is associated with all the search conditions input during an execution period of the search processing.

Furthermore, a first program product according to the present invention stores a computer-executable program for embodying a database search method for searching a database for data in a recording medium. The program includes instructions for allowing a computer to execute the following operations of: measuring an input number of search conditions input during a period from a start to an end of search processing; receiving an input of a message describing know-how information corresponding to contents of the search processing from a user, in a case where the input number measured at the end of the search processing exceeds a predetermined threshold value; and storing the input message in a know-how database under a condition that the input message is associated with all the search conditions input during an execution period of the search processing.

Furthermore, a second program product according to the present invention stores a computer-executable program for embodying a database search method for searching a database for data in a recording medium. The program includes instructions for allowing a computer to execute the following operations of measuring a necessary time taken from a start to an end of search processing; receiving an input of a message describing know-how information corresponding to contents of the search processing from a user, in a case where the necessary time measured at the end of the search processing exceeds a predetermined threshold value; and storing the input message in a know-how database under a condition that the input message is associated with all the search conditions input during an execution period of the search processing.

According to the above configuration, the program is loaded onto a computer for execution, whereby a user is prompted to register precautions, know-how for interpreting data, and the like to be output in accordance with an input situation of search conditions in user's search processing under a condition that precautions, know-how for interpreting data, and the like are associated with the search conditions, without being aware of registration. Therefore, a database search system can be realized in which a user can register know-how without fail.

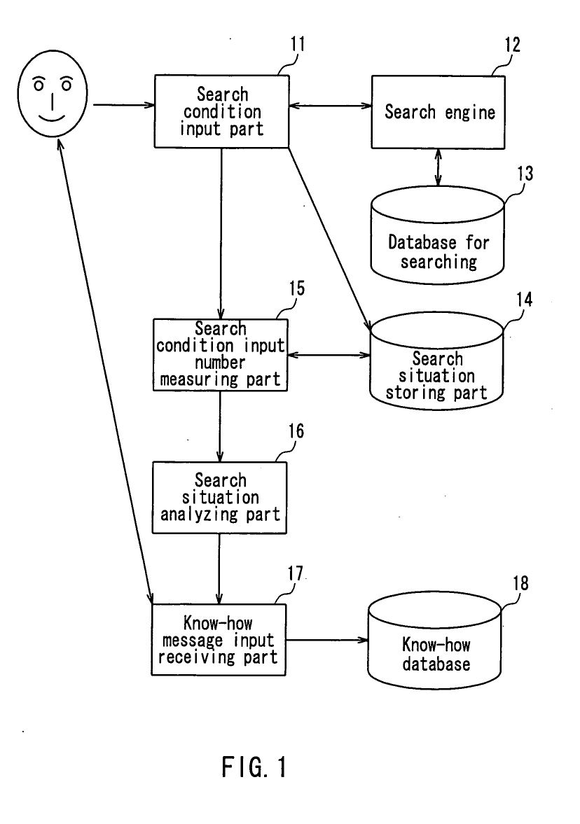

Hereinafter, a database search system according to an embodiment of the present invention will be described with reference to the drawings. FIG. 1 is a diagram showing a configuration of an accumulation system of information on know-how in the database search system according to the embodiment of the present invention.

In FIG. 1, a user inputs a search condition from a search condition input part 11. The search condition input part 11 is the same as that provided in a typical database search system. The search condition input part 11 refers to a database 13 to be searched, by using a search engine 12 based on the input search condition. A series of search conditions input during search processing are recorded in a search situation storing part 14.

Then, a search condition input number measuring part 15 counts how many times search conditions are updated and input during a period from the start to the end of the search processing. A start point of the search processing can be determined by a first input of a search condition. An end point of the search processing can be determined by detecting that an elapsed time after inputting a search condition finally becomes longer than a predetermined time, and the like. A method for determining a start point and an end point of the search processing is not limited to the above. Any method may be used as long as it can specify a start point and an end point.

The search conditions input during a period from the start to the end of the search processing are counted.

Next, a search situation analyzing part 16 determines whether or not an accumulated value of an updated number of search conditions detected in the search condition input number measuring part 15 exceeds a predetermined threshold value at the end of the search. In the case where the accumulated value exceeds the predetermined threshold value, it is determined that inputs of search conditions have taken time due to some problems occurring during the search processing, and a message acquisition request signal is transmitted to a know-how message input receiving part 17.

The know-how message input receiving part 17 that has received the message acquisition request signal requests the user to input information on the problems occurring during the search processing as a know-how message by using a pop-up window or the like. A request method with respect to the user is not particularly limited to the above, and a method for outputting a message, for example, and the like may be used.

When a know-how message is input by the user, the know-how message is recorded in the know-how database 18, together with a search condition based on which the search situation analyzing part 16 determines to request the user to input the know-how message.

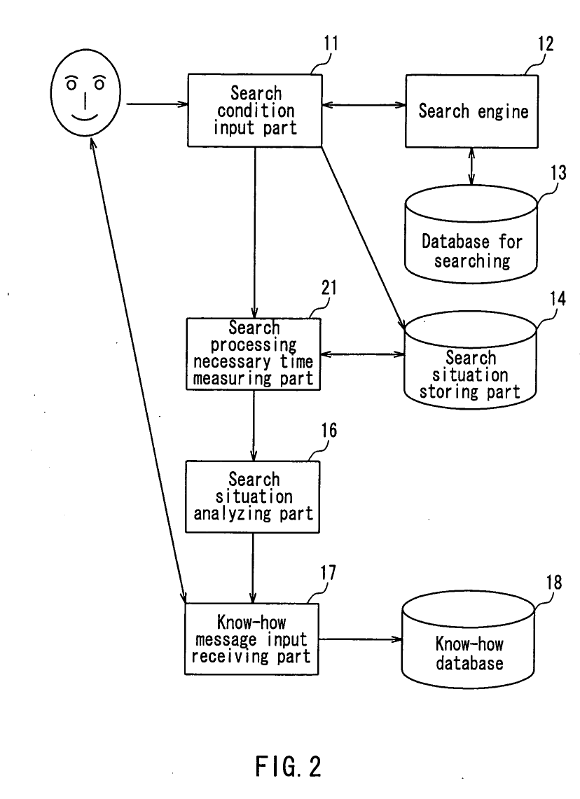

In place of the search condition input number measuring part 15, a search processing necessary time measuring part 21 may be used, as shown in FIG. 2. The search processing necessary time measuring part 21 measures time taken from the start to the end of the search processing.

A start point of the search processing can be determined by a first input of a search condition. An end point of the search processing may be determined by detecting that an interval between search condition inputs becomes longer than a predetermined period, or by pressing a search end button or inputting a search end command. A method for determining a start point and an end point of the search processing is not limited to the above, and any method may be used as long as it can specify a start time and an end time.

The search situation analyzing part 16 determines whether or not the necessary time for the search processing detected in the search necessary time measuring part 21 exceeds a predetermined threshold value at the end of the search. In the case where the necessary time exceeds the predetermined threshold value, it is determined that inputs of search conditions have taken time due to some problems occurring during the search processing, and a message acquisition request signal is transmitted to a know-how message input receiving part 17.

The following may also be possible: the user checks a pair of data of a know-how message to be recorded in the know-how database 18 and a series of search conditions before registration, and registers the search conditions in the know-how database under the condition that the search conditions determined to be unnecessary are deleted. According to this, search conditions can be excluded, which would be input by trial and error until desired data is finally found, and end up being unnecessary for the search processing, whereby the quality of a know-how message can be enhanced.

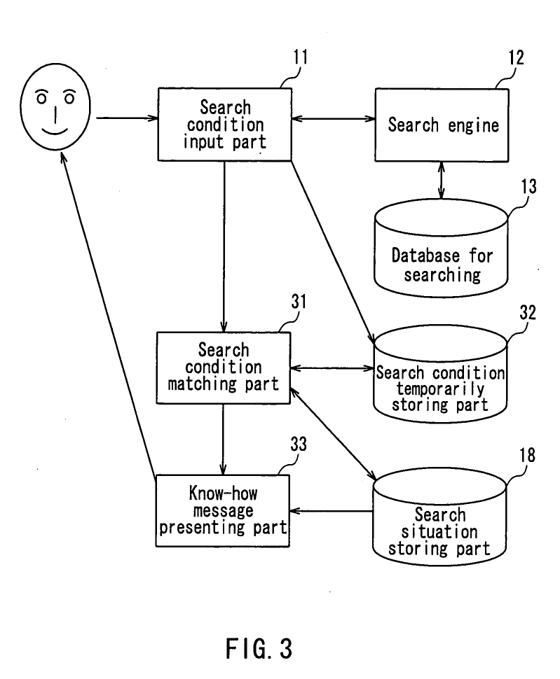

FIG. 3 is a diagram showing a configuration of a reference system of information on know-how in the database search system according to Embodiment 1 of the present invention. In FIG. 3, the components having the same functions as those in FIGS. 1 and 2 are denoted with the same reference numerals as those therein, and the detailed description thereof will be omitted here.

In FIG. 3, a search condition matching part 31 monitors search conditions input from the search condition input part 11 every time they are input. A search condition temporarily storing part 32 temporarily stores the input search conditions. In the search condition temporarily storing part 32, for example, in the case where a threshold value of an input number of search conditions is 5, the previous four search conditions are stored temporarily.

Next, the input search conditions or the past search conditions stored in the search condition temporarily storing part 32 are compared with the search conditions in the case where a know-how message stored in the know-how database 18 is required. In the case where a predetermined number of or more search conditions matched with the search conditions stored in the know-how database 18 have been input, a know-how message corresponding to the search conditions is transmitted to a know-how message presenting part 33, and output for display as related know-how information to the user by a pop-up window or the like.

The predetermined number may be “1”. However, if know-how is output when at least one search condition is matched, know-how will be displayed even in unrelated search processing, which may be determined not to be preferable. In such a case, the predetermined number may be set to be “2” or more.

Furthermore, the data configuration stored in the know-how database 18 is not limited to a pair of data of a search condition and a know-how message.

Thus, the fact that it has taken time for obtaining the search result data can be registered, and a user can obtain more efficient search know-how in the case where a search subject is matched.

Furthermore, it is also considered that a know-how message stored in the know-how database 18 is presented to all the users without any distinction. In this case, there is a possibility that a know-how message less related to a user may be displayed depending upon the search condition.

As a consequence, it is considered that the attribute of a user is specified by using user identification information such as a log-in ID or the like, and a know-how message of interest is presented to only a user having the attribute specified by a register of the know-how message of interest. As the attribute to be specified, for example, information such as a log-in ID belonging to a particular section, a log-in ID belonging to a particular project, and the like are considered. Because of this, a know-how message can be shared exclusively by related persons requiring the know-how, and a less related know-how message is not likely to be displayed every time search processing is performed. Thus, more efficient search processing can be performed.

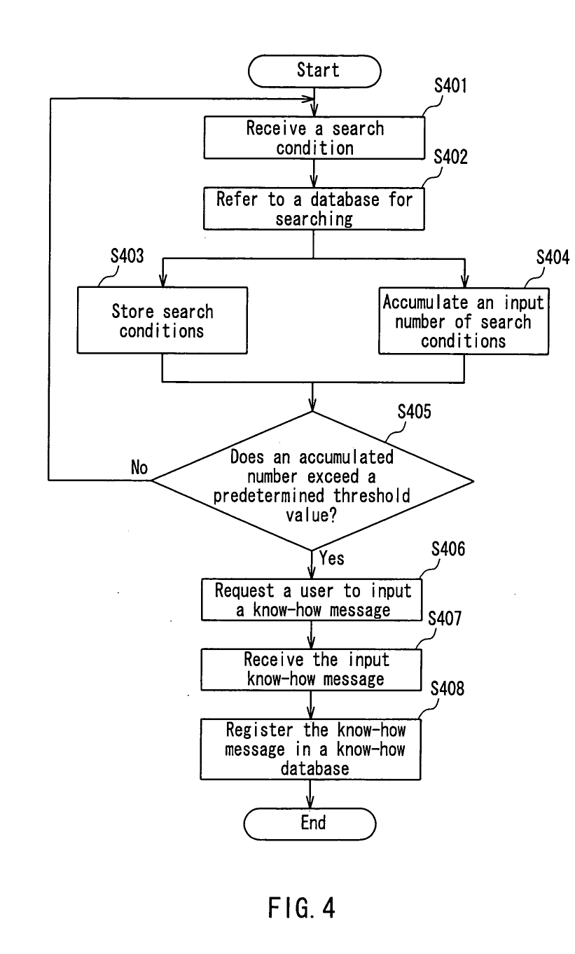

Next, the processing flow of a program for realizing the database search system according to the embodiment of the present invention will be described. FIG. 4 shows a flow diagram showing the processing of a program of an accumulation system of information on know-how in the database search system according to the embodiment of the present invention.

In FIG. 4, first, a search condition input by a user is received (Operation 401). The database 13 to be searched is referred to by using the search engine 12 based on the input search condition (Operation 402), and a series of search conditions input during search processing are stored (Operation 403).

Simultaneously, the input number of the search conditions is accumulated during a period from the start to end of the search processing (Operation 404). Then, it is determined whether or not an accumulated value of the updated number of the search conditions exceeds a predetermined threshold value (Operation 405).

In the case where the accumulated value of the input number of the search conditions exceeds the predetermined threshold value at the end of the search (Operation 405: Yes), it is determined that the inputs of the search conditions have taken time due to some problems occurring during the search processing, and the user is requested to input information on the problems occurring during the search processing as a know-how message by using a pop-up window or the like (Operation 406).

When the know-how message input by the user is received (Operation 407), the know-how message is recorded in the know-how database 18 under the condition of being paired with the search condition based on which it is determined to request the user to input the know-how message (Operation 408).

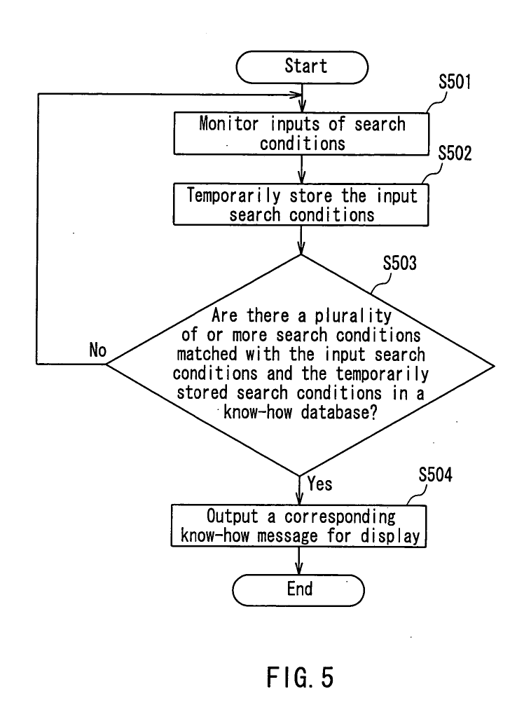

Next, FIG. 5 shows a flow diagram showing the processing of a program of a reference system of information on know-how in the database search system according to the embodiment of the present invention. In FIG. 5, what search conditions have been input are monitored every time they are input (Operation 501), and the input search conditions are temporarily stored (Operation 502).

Next, the input search conditions or the temporarily stored past search conditions are compared with search conditions in the case where a know-how message stored in the know-how database 18 is required (Operation 503).

In the case where a predetermined number of or more search conditions matched with the search conditions stored in the know-how database 18 are input (Operation 503: Yes), a know-how message corresponding to the search conditions is output for display as related know-how information to the user by a pop-up window, etc. (Operation 504).

As described above, according to the present embodiment, precautions at a time of search, know-how for interpreting data, and the like can be output in accordance with input situations of search conditions in user's search processing without user's intentional search.

Furthermore, a method for outputting a know-how message that is information on know-how is not limited to text data input using an input medium such as a keyboard by a user. For example, the contents of user's utterance are recorded as they are and accumulated as voice data, and are reproduced as a voice message to a user during search processing.

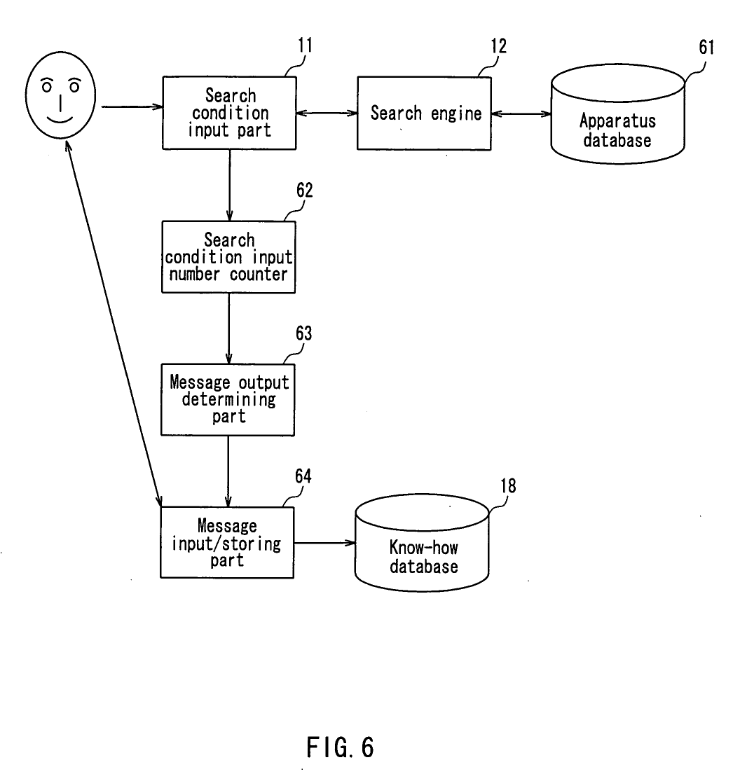

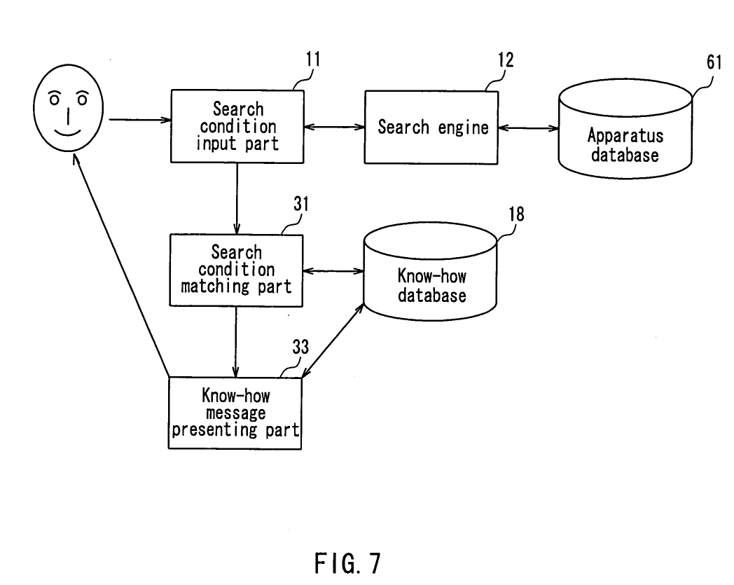

Hereinafter, as an example of the present invention, a database search system for specifying a client delivery apparatus will be described. FIGS. 6 and 7 show configurations of a client database search system of the example according to the present invention. FIG. 6 shows a configuration of an accumulation system of information on know-how, and FIG. 7 shows a configuration of a presentation system of information on know-how, respectively. The present example is directed to a system for matching an apparatus having trouble, which a client supporting operator is notified of in a help desk system for a personal computer, etc. by a user using the system, with an apparatus database 61 created at the delivery of the apparatus.

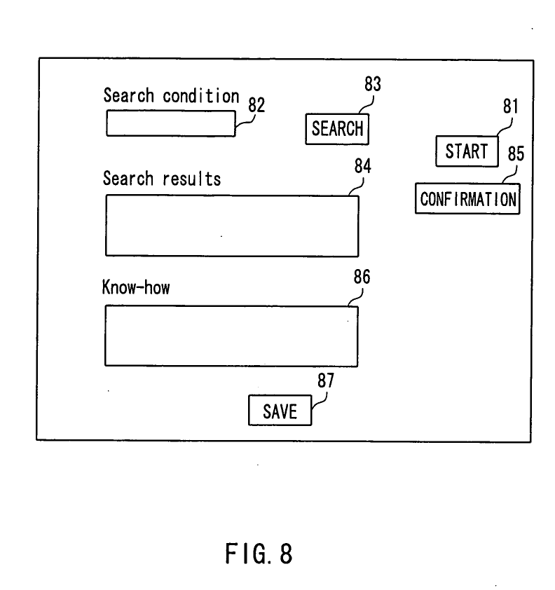

FIG. 8 illustrates a screen of the client database search system of the present example. As shown in FIG. 8, first, in an accumulation phase of information on know-how, an operator who is a user of the system presses a “start” button 81, thereby starting search processing for confirming whether or not an apparatus having trouble is actually registered in the apparatus database 61.

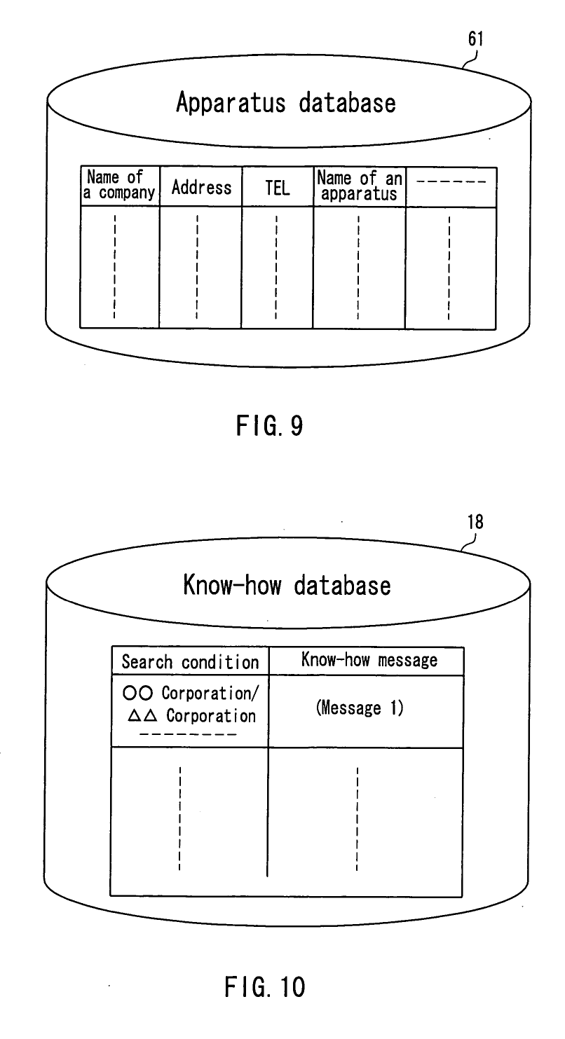

FIG. 9 is a diagram showing a data configuration of the apparatus database 61. As shown in FIG. 9, in the apparatus database 61, a name and an address of a company that has installed the apparatus, or a name, a serial number, etc. for identifying the apparatus are registered.

A search condition is input in a search condition input area 82, and a “SEARCH” button 83 is pressed, whereby search results are displayed in a search result display area 84. When data regarding the corresponding apparatus can be specified as search results after the above operation is repeated a required number of times, a “CONFIRMATION” button 85 is pressed.

At a time when the “CONFIRMATION” button 85 is pressed, it is determined in a message output determining part 63 whether or not the number of presses of the “SEARCH” button 83 measured by a search condition input number counter 62 exceeds a predetermined threshold value. In the case where it is determined that the number of presses exceeds the predetermined threshold value, a message input/storing part 64 displays a know-how input area 86 on a screen of a user.

When the know-how input area 86 is displayed, the user inputs information on related know-how, and presses a “SAVE” button 87. At a time when the “SAVE” button 87 is pressed, the message input/storing part 64 associates the input information on know-how with a search condition, and accumulates it in the know-how database 18.

FIG. 10 is a diagram showing a data configuration of the know-how database 18. As shown in FIG. 10, a know-how message input by a user, as well as a search condition that is input a plurality of times, are recorded as a pair of data.

Next, in a know-how reference phase, while a user is executing search processing by inputting a search condition so as to specify an apparatus having trouble, the search condition input by the user in the search condition matching part 31 is always compared with search conditions accumulated in the know-how database 18. In the case where at least one search condition input by the user is matched with the search conditions in the know-how database 18, a corresponding know-how message is displayed in the know-how area 86 (that is the same as a know-how describing area 86 in FIG. 8) by using a pop-up window to issue a warning to the user.

The user can obtain important hints and dues for completing current apparatus search processing by referring to the displayed know-how message, whereby more efficient search processing can be performed.

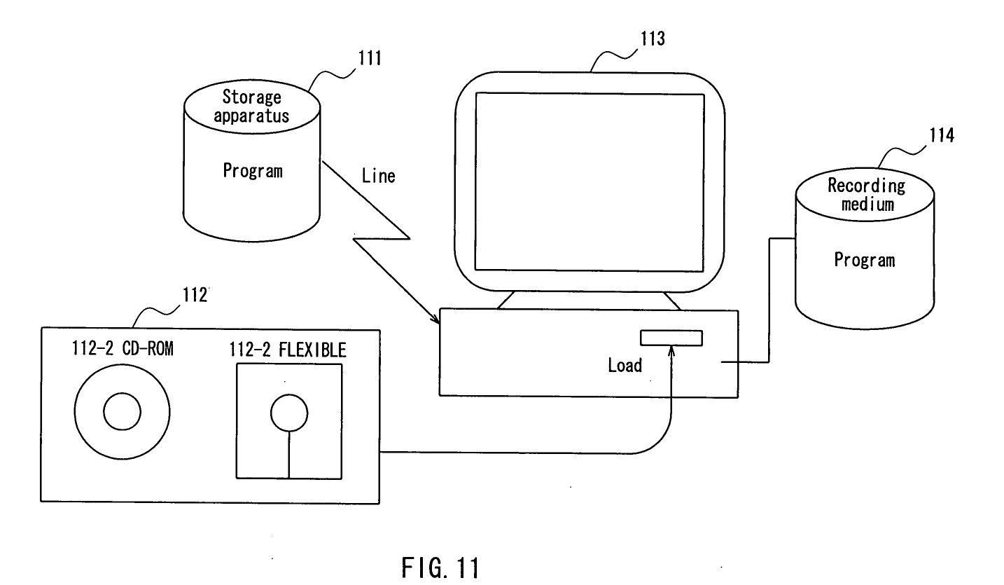

A program for realizing the database search system according to the present embodiment of the present invention may be stored not only in a portable recording medium 112 such as a CD-ROM 112-1 and a flexible disk 112-2, but also in another storage apparatus 111 provided at the end of a communication line, or a recording medium 114 such as a hard disk of a computer 113 and a RAM, as shown in FIG. 11. In execution of the program, the program is loaded and executed on a main memory.

Furthermore, information on know-how generated by the database search system and the like according to the embodiment of the present invention may also be stored not only in a portable recording medium 112 such as a CD-ROM 112-1 and a flexible disk 112-2, but also in another storage apparatus 111 provided at the end of a communication line, or a recording medium 114 such as a hard disk of a computer 113 and a RAM, as shown in FIG. 11. Such information is read by the computer 113, for example, when the database search system of the present invention is used.

As described above, according to the database search system of the present invention, the case in which it has taken time to specify data to be searched is detected automatically, and a user is prompted to record information on know-how for avoiding such a situation, whereby information on know-how can be accumulated exhaustively and exactly.

Furthermore, according to the database search system according to the present invention, a user using a search condition similar to the case in which it has taken time to specify data to be searched can be provided with information on corresponding know-how. Therefore, information on know-how useful for executing search can be effectively shared by users, and more efficient search processing can be executed.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A database search system for searching a database for data, comprising:
a unit for measuring an input number of search conditions input during a period from a start to an end of search processing;
a unit for receiving an input of a message describing know-how information corresponding to contents of the search processing from a user, in a case where the input number measured at the end of the search processing exceeds a predetermined threshold value; and
a unit for storing the input message in a know-how database under a condition that the input message is associated with all the search conditions input during an execution period of the search processing.

2. The database search system according to claim 1, wherein during execution of the search processing, the search conditions input by the user are compared with search conditions stored in the know-how database every time the search conditions are received, and in a case where a predetermined number of or more search conditions are matched with each other, the message associated with the search conditions stored in the know-how database is output to the user.

3. The database search system according to claim 1, wherein when the user inputs the message on know-how, another or a plurality of users to be provided with the message is specified, and the message is output only to the another or plurality of users.

4. The database search system according to claim 1, wherein the message is voice data storing uttered contents of the user.

5. The database search system according to claim 1, wherein when the user inputs the message on know-how, the search condition which is associated with know-how is selectable by the user from a plurality of the search conditions.

6. A database search system for searching a database for data, comprising:
a unit for measuring a necessary time taken from a start to an end of search processing;
a unit for receiving an input of a message describing know-how information corresponding to contents of the search processing from a user, in a case where the necessary time measured at the end of the search processing exceeds a predetermined threshold value; and
a unit for storing the input message in a know-how database under a condition that the input message is associated with all the search conditions input during an execution period of the search processing.

7. The database search system according to claim 6, wherein during execution of the search processing, the search conditions input by the user are compared with search conditions stored in the know-how database every time the search conditions are received, and in a case where a predetermined number of or more search conditions are matched with each other, the message associated with the search conditions stored in the know-how database is output to the user.

8. The database search system according to claim 6, wherein when the user inputs the message on know-how, another or a plurality of users to be provided with the message is specified, and the message is output only to the another or plurality of users.

9. The database search system according to claim 6, wherein the message is voice data storing uttered contents of the user.

10. The database search system according to claim 6, wherein when the user inputs the message on know-how, the search condition which is associated with know-how is selectable by the user from a plurality of the search conditions.

11. A database search method for searching a database for data, comprising;
measuring an input number of search conditions input during a period from a start to an end of search processing;
receiving an input of a message describing know-how information corresponding to contents of the search processing from a user, in a case where the input number measured at the end of the search processing exceeds a predetermined threshold value; and
storing the input message in a know-how database under a condition that the input message is associated with all the search conditions input during an execution period of the search processing.

12. A database search method for searching a database for data, comprising;
measuring a necessary time taken from a start to an end of search processing;
receiving an input of a message describing know-how information corresponding to contents of the search processing from a user, in a case where the necessary time measured at the end of the search processing exceeds a predetermined threshold value; and
storing the input message in a know-how database under a condition that the input message is associated with all the search conditions input during an execution period of the search processing.

13. A program product storing a computer-executable program for embodying a database search method for searching a database for data in a recording medium, the program comprising instructions for allowing a computer to execute the following operations of:
measuring an input number of search conditions input during a period from a start to an end of search processing;
receiving an input of a message describing know-how information corresponding to contents of the search processing from a user, in a case where the input number measured at the end of the search processing exceeds a predetermined threshold value; and
storing the input message in a know-how database under a condition that the input message is associated with all the search conditions input during an execution period of the search processing.

14. A program product storing a computer-executable program for embodying a database search method for searching a database for data in a recording medium, the program comprising instructions for allowing a computer to execute the following operations of:
measuring a necessary time taken from a start to an end of search processing;
receiving an input of a message describing know-how information corresponding to contents of the search processing from a user, in a case where the necessary time measured at the end of the search processing exceeds a predetermined threshold value; and
storing the input message in a know-how database under a condition that the input message is associated with all the search conditions input during an execution period of the search processing.
